(19) United States
(12) Patent Application Publication
(10) Pub. No.: US 2010/0161411 A1
(43) Pub. Date: Jun. 24, 2010

(54) SYSTEM AND METHOD FOR GENERATING DISPLAY ADVERTISEMENTS FROM SEARCH BASED KEYWORD ADVERTISEMENTS

(75) Inventors: Wang Wu, Los Altos, CA (US); Dorothy Tse, San Francisco, CA (US); Michael Gassewitz, Ottawa (CA); Sitao Yang, Sunnyvale, CA (US)

Correspondence Address: OSHA LIANG L.L.P., TWO HOUSTON CENTER, 909 FANNIN, SUITE 3500, HOUSTON, TX, 77010, US

(73) Assignee: KINDSIGHT, Sunnyvale, CA (US)

(21) Appl. No.: 12/645,344

(22) Filed: Dec. 22, 2009

Related U.S. Application Data
(60) Provisional application No. 61/140,068, filed on Dec. 22, 2008.

(51) Int. Cl. G06Q 30/00; G06Q 10/00; G06F 17/30

(52) U.S. Cl. 705/14.45; 705/14.48; 705/14.53; 705/14.72; 707/737; 707/E17.089

(57) ABSTRACT

There is provided a system and method for generating display advertisements from search based keyword advertisements. The system includes a keyword generation unit for generating one or more advertising keywords from a received category profile defining a classification hierarchy, for use in selecting one or more candidate advertisement messages from a plurality of advertisement messages, an advertisement selection unit for receiving one or more candidate advertisement messages comprising a text message selected from the plurality of advertisement messages and selecting one advertisement message from the one or more received candidate advertisement messages based upon one or more characteristics associated with the received one or more candidate advertisement messages and a creative advertisement assembly unit for generating an advertisement image based on the text advertisement of the selected one advertisement message for display in network based content.

### CROSS-REFERENCE TO RELATED APPLICATIONS

This application claims priority, under 35 U.S.C. §119(e), to U.S. Provisional Patent Application Ser. No. 61/140,068, filed on Dec. 22, 2008. U.S. Provisional Patent Application Ser. No. 61/140,068 is hereby incorporated by reference in its entirety.

### TECHNICAL FIELD

The present disclosure relates to the field of Internet marketing (a.k.a. web marketing). In particular, to an apparatus and a method for mapping search-based keyword advertising to behavioral intent categories.

### BACKGROUND

Advertising presented on Web pages on the Internet have traditionally included two types of advertisements (a.k.a. ads). The first type includes advertisements that are typically presented on search results pages of search engines such as, for example, Google™. The advertisements are typically composed of text only. The selection of text to include in an advertisement is a function of the search keywords that were provided by a user to the search engine and that resulted in the search results pages on which the advertisement is displayed. This type of advertisement is known as search engine marketing (SEM) where advertisers choose search keywords that trigger an ad to be delivered on the search results pages. The second type includes advertisements that are typically presented on Web content pages such as, for example, the New York Times (NYTimes.com) sports page. These advertisements are typically predominately graphic with some text. The selection of advertisement content is a function of a classification (i.e. a categorization) of the contents of the Web content page. This type of advertisement is known as display advertising and can be targeted in several ways including, for example, contextually targeted to a context of the content page, and behaviorally targeted to the user receiving the ad.

Traditionally, keyword search engine advertisements (i.e. SEM) are delivered on the search results pages of search engines. Search engine advertisers focus on which precise search terms they buy ad inventory for in order to reach prospective customers. Search keyword advertising is mainly a direct response form of advertising. It is based on the user's expressed interest and intent with the expectation of a direct response to the advertisement being converting to a click or sale. Search marketers can specify different advertisement (a.k.a. ad) messages for each keyword purchased. The search marketers can also customize (i.e. configure) a Universal Resource Locator (URL) designating a landing page (i.e. a Web page) for a click-through of the advertisement as a function of a keyword purchased. Currently, there is no automated mechanism to take SEM ads and deliver them to an audience outside of the search results pages other than through a contextual targeting approach. Contextual targeting is ad targeting based on the context of the web page the ad will be delivered on. Key terms are extracted from the page to deliver relevant keyword ads. This approach requires the analysis of each web page before an advertisement can be placed on the web page.

Behavioral advertisement targeting (i.e. behaviorally targeted) is traditionally purchased at a category level. This is due to the fact that this form of targeting is delivered on content pages and behavioral targeting advertisers utilize display advertising with typically no more than 2-5 different graphical display ads. Though marketers want to reach a precise audience group, their medium to deliver their ads have been display (i.e. graphically) oriented and therefore does not have the flexibility that SEM offers. Display ads have an associated creative cost and are not as easily customizable to fine grain levels as are SEM (i.e. keyword) advertisements. The problem is that there is currently no mechanism to take SEM offers (i.e. keyword advertisements) and deliver them using a behaviorally targeted approach on content pages on the web.

Therefore there is a need for an advertising system that is capable of generating display ads using keyword ads.

### SUMMARY

In accordance with the present disclosure there is provided an online advertising system comprising a computer readable memory for storing instructions and a processing unit for executing the instructions stored in the computer readable memory. When executed by the processing unit, the instructions configuring the processing unit and the computer readable memory to provide a keyword generation unit for generating one or more advertising keywords from a received category profile defining a classification hierarchy, the generated one or more advertising keywords associated with the classification hierarchy of the received category profile, the generated one or more advertising keywords for use in selecting one or more candidate advertisement messages from a plurality of advertisement messages, an advertisement selection unit for receiving one or more candidate advertisement messages selected from the plurality of advertisement messages, each of the received candidate advertisement messages comprising a text advertisement associated with at least one of the generated one or more advertising keywords, and selecting one advertisement message from the one or more received candidate advertisement messages based upon one or more characteristics associated with the received one or more candidate advertisement messages, and a creative advertisement assembly unit for generating an advertisement image based on the text advertisement of the selected one advertisement message for display in network based content.

In accordance with the present disclosure there is further provided a computer implemented method of generating an advertisement image for display in web based content on a client computing device. The method comprises receiving a category profile defining a classification hierarchy, retrieving from a keyword mapping repository one or more advertising keywords associated with the classification hierarchy of the received category profile, receiving one or more candidate advertisement messages, each of the one or more candidate advertisement messages selected from a plurality of advertisement messages and comprising a text advertisement associated with at least one of the generated one or more advertising keywords; selecting one advertisement message from the selected one or more received candidate advertisement messages based upon one or more characteristics associated with the received one or more candidate advertisement messages, and generating an advertisement image based on the text advertisement of the selected one advertisement message for display in network based content.

### BRIEF DESCRIPTION OF THE DRAWINGS

Embodiments of the present disclosure are described with reference to the drawings in which:

FIG. 1 depicts in a block diagram an environment in which the current advertising system may be practiced;

FIG. 2 depicts in a block diagram an further illustrative environment in which the current advertising system may be practiced;

FIG. 3a depicts in a schematic a portion of an intent ontology;

FIG. 3b depicts a profile that can be generated in accordance with the intent ontology of FIG. 3a;

FIG. 3c depicts an illustrative category-to-keyword mapping for the portion of the intent ontology of FIG. 3a

FIG. 4 depicts an illustrative implementation of an display ad server;

FIG. 5 depicts in a schematic an illustrative information flow between components of the environment in which the display ad generator may be used;

FIGS. 6a and 6b depict in a message flow diagram a corresponding illustrative flow of messages between the components;

FIG. 7 depicts in a flow chart an illustrative method of generating a display ad from a text based keyword ad; and

FIG. 8 depicts in a flow chart a method of generating a display ad based on a text message.

### DETAILED DESCRIPTION

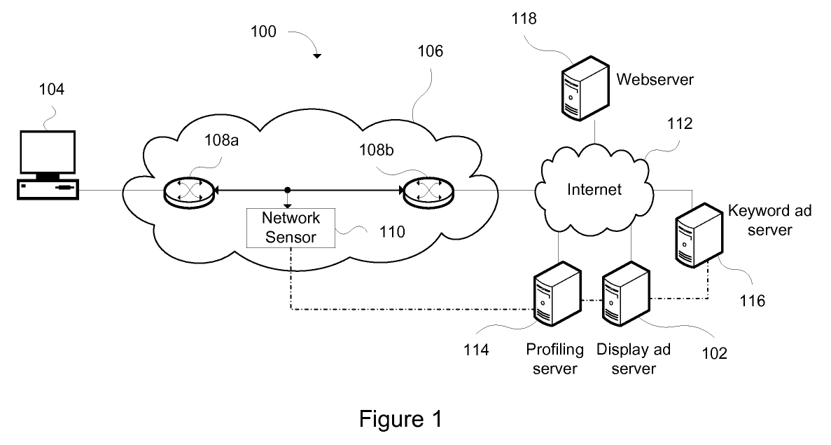

FIG. 1 depicts in a block diagram an environment in which the current advertising system may be practiced. The environment 100 includes an display ad server 102 for serving displaying advertisements. The environment 100 also includes a computer, or other network connected device, 104 connected to an Internet Service Provider (ISP) network 106. The ISP network 106 includes a plurality of routers or switches 108a, 108b for directing packets through the ISP network 106. One or more network sensors 110 may copy and forward network traffic to other components of the environment 100. The ISP network 106 connects the computer 104 to the Internet 112. The network sensors may forward network traffic to a profiling server 114 for generating a subscriber profile based on a subscribers web traffic. The profiling server 114 is coupled, either directly or indirectly through the ISP network 106 or Internet 112, to the display ad server 102 in order to provide a profile to the display ad server 102. The display ad server 102 is also coupled, either directly or indirectly, to a keyword ad server 116 that can provide keyword based advertisements to the display ad server 102. The environment 100 further includes a web server 118 for delivery web content, that includes a display advertisement to be provided by the display ad server 102, to the computer 104.

The display ad server 102 receives a request for an advertisement (a.k.a. an ad call, or an ad request) to be displayed on a web page being viewed in a browser on the computer 104. The web page can be any web content page such as, for example, the New York Times (NYTimes.com) sports page or any other type of network content. The web content page includes provisions for the presentation of one or more advertisements (e.g. banner ads) together with the web page contents. The browser can be running on the computer that is connected to the Internet 112 via the ISP network 106 infrastructure. The request for an advertisement contains a user identifier associated with the user. The display ad server 102 requests a user profile associated with the user identifier from the profiling server 114.

The user profile received from the profiling server 114 may contain a plurality of category-score pairs. Each category-score pair comprises a category identifier selected from a hierarchy of categories defined in an intent ontology. Each category of the intent ontology represents an area of interest or preference that a user may have. The score in each category-score pair of a user profile represents the strength of the user's interest in, or preference for, the category in the pair. The user profile provided by the profiling server 114 is provided to the display ad server 102, which uses the profile to derive keywords. The keywords are provided to a keyword ad system 116 that provides candidate advertisements. The candidate advertisements are text based advertisements containing, or associated with, keywords that match the selected keywords derived from the categories in the user profile. The display ad server 102 selects a single advertisement from the candidate advertisements and generates a display advertisement that is returned for display in the content on the computer 104.

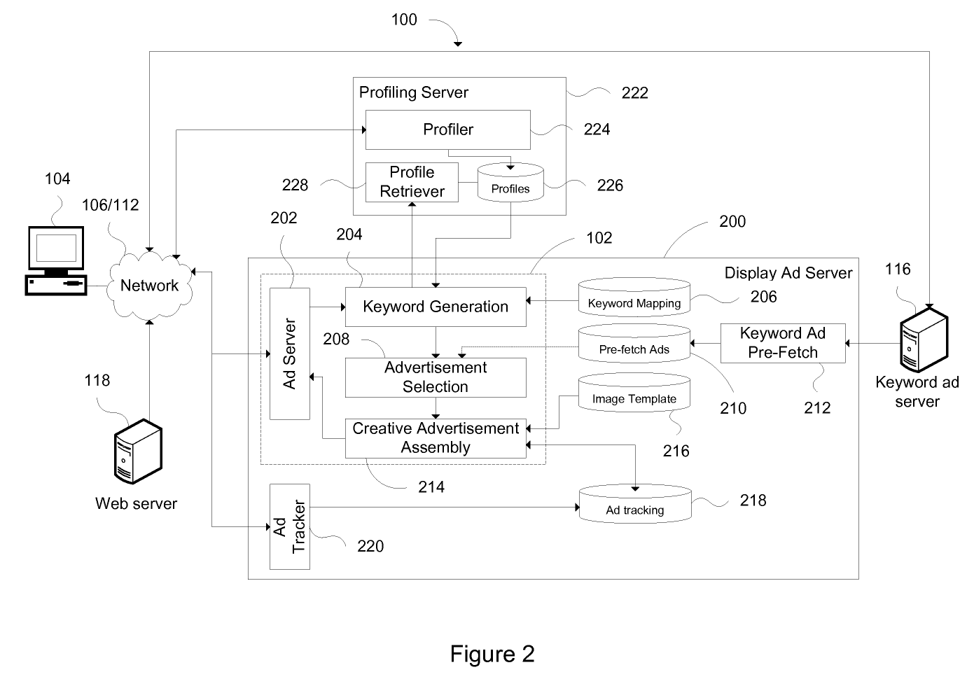

FIG. 2 depicts in a block diagram an further illustrative environment in which the current advertising system may be practiced. The environment 100 includes the computer 104 coupled a network comprising the ISP network 106 and the Internet 112. Also coupled to the network 106, 112 is the web server 118 and keyword ad server 116. As will be readily apparent to one skilled in the art, the web server 118 provides content to the computer 104 for display in response to requests it has received. Similarly the keyword ad server 116 provides text based advertisements to a requester in response to requests. The request to the ad server may specify one or more keywords to use in selecting the text based advertisement returned in response to the request.

The environment 100 further includes a display ad system 200. The display ad system 200 receives a request for a display ad from a browser on the computer and generates the display ad based on a text based ad as described further herein. The environment 100 may also include a profiling server 222 that can generate a profile of a user based on their network traffic, or more particularly their web usage traffic. The profiles may be created using various profiling algorithms including machine based and rules based algorithms. The profiling server 222 may provide the profile to the display ad system for use in selecting the text based ad to use in generating the display ad. As described further herein the profile may be a user profile, or if a user profile is not available it may be a web page profile based on the content of the page that the display ad is included in.

The display ad system 200 comprises the display ad server 102 and may optionally include further components as described herein. It will be apparent to one skilled in the art, that although the different components of the display ad system are described separately, this is done for clearly describing the functioning of the system, and other specific implementations are possible.

The display ad server 102 includes an ad server 202 that receives requests for a display ad and returns a generated display ad in response. The request for a display ad may be formatted in various ways, but typically the request is included in a web page to be displayed as a section in the web page's Hyper Text Transfer Protocol (HTTP) description. The request may be incorporated into the web page's description, using for example HTML code and/or JavaScript code. One illustrative example of a display ad request that may be included in a web page is:

<script language=“javascript”>

var docref=“none”;
var docurl=“none”;
var random=(new Date( )).getTime( );
if (document.referrer && document.referrer != “”) {

docref=document.referrer;}

if (document.URL && document.URL != “”)
{ docurl=document.URL;}
document.writeln(‘<iframe width=728 height=90 align=middle

scrolling=no marginheight=0 marginwidth=0 frameborder=0
src=“http://ads.example.com/adserving/adrequest?w=728&h=90&rq=62&
ref=‘ + escape(docref) + ’&url=‘ + escape(docurl) + ‘&rand=’ +
random + ‘”></iframe>’);
</script>

In the above example the variable ‘docref’ provides an indication, if available to the browser, of the referring document. The referring document is a web page that provided a link to the currently displayed web page (with the display ad) that a user clicked on. The ‘docurl’ variable provides the Uniform Resource Locator (URL) of the currently displayed web page. The variable ‘random’ provides a random number that is used to ensure that if the web page is stored in a local cache, it will receive a new display ad each time it is viewed.

The above code inserts an iframe element with a determined size and position into the web page. The script also specifies the location from where to retrieve the description of the content of the iframe. The location provides the request to the ad server to generate and return the display ad. As depicted above, the request is sent to the location ‘ads.example.com/adserving’, and in particular to the ‘adrequest’ service at that location. The request also includes information specifying that the width (w=) of the display ad is 728 pixels, the height (h=) is 90 pixels. The request may also specify an identifier of the publisher of the web content that includes request for the display advertisement (rq=62). The request may also include the ‘docref’, ‘docurl’ and ‘random’ variables. As will be appreciated by those skilled in the art, the request will include additional information, which may be added by the browser or the transport protocols. This additional information may include for example an identifier for identifying the computer 104 that the request is sent from. This may include an Internet Protocol (IP) address, a Machine Access Control (MAC) address, or other similar information. The request may also include an indication of the browser that the display ad will be displayed in, which may be used in generating the display ad response.

The ad server 202 receives the request and generates the display ad based on the request. The response may comprise an HTML description of the content to be included in the iframe. The response may include an image tag <IMG> specifying the location of the generated display ad to be displayed, as well as a click thru location specifying the location to be displayed if a user clicks on the display advertisement. The response may also include other elements, including for example, a tracking pixel for informing the display ad system that a display advertisement has been displayed, as well as script code for performing various functions, such as for example providing animation to the display ad, tracking of clicking on the advertisement etc.

Upon receiving the request, the ad server 202 begins the process of generating the display ad response. A keyword generation portion 204 requests a profile associated with the computer making the request. The association may be made using, for example the IP address or other identifier included in the request. The following assumes the identifier used is the IP address. The keyword generation portion 204 requests the profile associated with the IP address from a profiling server 222. A profile retriever portion 228 of the profiling server 222 receives the request and retrieves the associated profile from a profile repository 226. The profile is then returned to the keyword generation portion 204.

As described above, the profile may include a plurality of category-score pairs. The categories of the profile are based on an intent ontology that groups categories into hierarchies that describe a possible intent of a user. The keyword generation portion 204 uses a category-to-keyword mapping that is associated with the categories of the intent ontology to generate one or more keywords associated with the categories of the profile. The category-to-keyword mapping associated with the categories of the intent ontology may be stored in a keyword mapping repository 206.

The keyword generation portion 204 generates one or more keywords based on a received profile. The one or more keywords are used to retrieve one or more text based ads. The one or more text based ads may be retrieved in various ways. In the illustrative embodiment of FIG. 2, the text based ads are retrieved from a pre-fetch ad repository 210. The pre-fetch ad repository 210 stores a plurality of text based ads and associated information including, for example, a click thru address, the keywords the text based ad is associated with, a cost-per-click (CPC) of the text based ad, an advertiser identifier associated with the text based ad, an identifier that can uniquely identify the text based ad, etc. The pre-fetch ad repository may be populated, and periodically updated or changed, by a keyword ad pre-fetch portion 212. The keyword ad pre-fetch portion 212 periodically retrieves text based ads, and associated information, from one or more keyword ad servers 116. Although the above describes retrieving the text based ads from a pre-fetch ad repository 210, it will be apparent to one of ordinary skill in the art that it is also possible to retrieve the text based ads directly from the one or more keyword ad servers 116.

The retrieved one or more text based ads, referred to herein after as candidate ads, are received at an advertisement selection portion 208. The advertisement selection portion 208 may also receive the profile information, as well as the generated keywords, from the keyword generation portion, or other components of the display ad system 200. The advertisement selection portion 208 selects one text based ad from the candidate ads that will be used to generate the display ad. The selection of the keyword ad may be based on one or more characteristics associated with the candidate ads, the received profile, or a combination of the two. For example, the advertisement selection portion 208 may select the candidate ad with the highest CPC. The advertisement selection portion 208 may further base the selection on the relevance of the candidate ad. The relevance of each candidate ad may be determined in various ways. For example, the keywords generated from the profile may be compared to the words of the text ads to determine the candidate ad with the highest number of keywords. Additionally or alternatively, the relevance may be determined by determining a profile for each candidate add. The profile may be determined using, for example the category-to-keyword mapping of the intent ontology, in order to generate a category hierarchy based on either the keywords associated with the candidate ad, the text of the candidate ad or both. The generated profile may then be compared to the profile provided to the advertisement selection portion 208. The candidate ad with the profile that most closely matches the received profile may be selected as the most relevant. It will be apparent to one skilled in the art that the text based ad may be selected based on a weighted combination of the CPC of a candidate ad and its relevance. The advertisement selection portion may use different algorithms for selecting the keyword ad from the candidate ads. If multiple algorithms may be used, each algorithm may be associated with a unique identifier, and the identifier of the algorithm used to select the keyword ad may be associated with the generated display ad in order to track the performance of the ads selected by the algorithm.

The selected keyword advertisement from the candidate ads is received at a creative assembly portion 214. The creative assembly portion 214 generates the display ad, as well as any HTML or script code required to display the display ad in the content. The creative assembly retrieves an image template from an image template repository 216. Each image template stored in the image template repository 216 may define information on how to format the text of the selected keyword ad in order to generate the display ad. The template information may define, for example, an image height, an image width, a font size, a font color, a font position, a background color, a background pattern, a background image, a background image location, a foreground image, and a foreground image location. Other information may be defined by the templates. Additionally, each template may be associated with a unique identifier, in order to be able to track which template was used to generate a display ad. This information may be useful if the performance of the generated display ads is tracked, as it may be useful to be able to track the templates in order to determine if a particular template results in a higher click through rate.

The creative assembly portion 214 combines the selected template with the text of the selected keyword advertisement from the candidate ads in order to create an image used in the display advertisement. The creative assembly portion 214 also generates the code necessary in order to display the created image in the ad space in the content. If the ad is embedded within the content using an <iframe> as described above, the creative assembly may generate the HTML code necessary to display the image in the iframe. Additionally or alternatively, as will be apparent to one skilled in the art, the request may be incorporated in the URL of an image tag <IMG> in the content, in which case the creative assembly portion 216 need only return the created image.

It will be appreciated that the creative assembly portion 216 may select the template based on historical performance information stored in an ad tracking repository 218, the received profile, the web site the ad is being inserted into or a combination thereof.

In addition to the generating the display ad, which may simply comprise the created image, or may comprise the image as well as code required to display the image within the content, the creative assembly portion 216 may also generate additional code and or content to include in the display ad. This additional content may include a 1×1 pixel image which causes a request for the image to be sent to an ad tracker portion 220 once the created ad image has been displayed. The request may include information associated with the display ad and its creation. Alternatively, the creative assembly unit may assign a unique identifier to each advertisement and store the information associated with the generated image within the ad tracking repository 218. In such an instance the image request sent to the tracker portion may only need to include the unique identifier. Regardless of the particular method used to track the display of the display ad in the content, or impressions, the ad tracker portion 220 maintains this impression information in the ad tracking repository 218.

In addition to the impression tracking content, the display ad may also include click tracking code for tracking when or if the ad is clicked on. The click tracking code may comprise JavaScript code that is executed when the display ad is clicked. The JavaScript code may send the display ad information, or the unique ad identifier if used, to the ad tracker, along with an indication that that the associated information relates to a click on the display ad. This may be done by sending the information to a particular location. Although the JavaScript code may be used to send the information to a particular location, another possibility is to cause the link reference to provide the information to the same location in a request. The ad tracker may receive the request, update the ad tracking repository information accordingly and determine a click thru location associated with the display ad, and then redirect the browser to the location. The click thru location may be determined from the URL of the request, that is the information may be encoded into the request URL, or it may be stored in the ad tracking repository 218, or possibly a separate ad repository (not shown) that stores information pertaining to display ads that have been generated.

As described above, the display ad server 102 uses a profile, in combination with a category-to-keyword mapping, in order to generate the keywords used to retrieve a text based key word advertisement. The profile may be generated by a profiling server 222 that includes a profiler for generating the profile for a user by processing network traffic of the user. The profiler portion 224 may generate the category-score pairs for a user's profile. The profiler may also update the category-score pairs, either by adding or removing categories or modifying the score of existing pairs based on the traffic associated with the user. The traffic may be associated with the user through the user's IP address; however the IP address may be translated to a subscriber ID associated with the user. The IP address assigned to a user may change with time, however by mapping the IP address to a subscriber ID currently associated with the IP address, the user profile may still be retrieved even if the user is associated with a different IP address.

In addition to generating a profile for users the profiling system may also profile web pages. In order to modify a user's profile based on the web sites they are viewing, the web sites must also have an associated profile defining category-score pairs relevant to the content of the web page.

When requesting the profile, the keyword generation portion 204 may use either a user profile associated with the user that made the request, a web page profile associated with the request, or both. The keyword generation portion 204 may send the IP address and the web site URL that the ad is to be embedded within to the profiling system 222, or more particularly the profile retriever 228. The profiling server 222 may return the user profile associated with the IP address and the profile associated with the web page being viewed. It will be appreciated that if a user profile is not available the profiling server 222 may provide only the web site profile. Since both the web site profile and user profile are similar in that they comprise category-score pairs, the keyword generation portion 204 is capable of using either one. If both are available, the keyword generation portion 204 may combine the profiles together or may simply use one, for example the user profile, when determining the keywords.

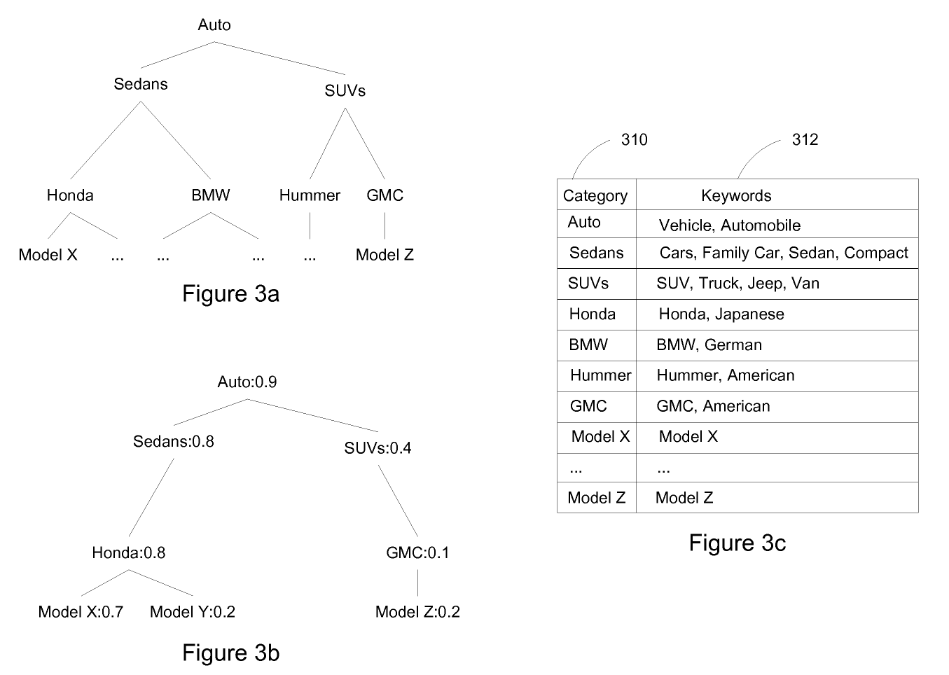

FIG. 3a depicts in a schematic a portion of an intent ontology. The intent ontology provides a hierarchical grouping of categories. The categories relate to categories of interest at finer and finer levels of detail. A single section of the intent ontology is depicted in FIG. 3a, however a full intent ontology would include additional categories, for example news, computers, education etc. Additionally, the full intent ontology may include further, broader, groupings of categories above ‘Auto’, such as, for example ‘Transportation’. As depicted in FIG. 3a, the intent ontology provides hierarchical groupings of categories. So for example, the category ‘Auto’ may be used to broadly group the categories ‘Sedans’ and ‘SUVs’. Similarly ‘Sedans’ may broadly groups ‘Honda’ and ‘BMW’. ‘Honda’ and ‘BMW’ may in turn group their particular models that are sedans. Similarly ‘SUVs’ may broadly group ‘Hummer’ and ‘GMC’ which may in turn group their particular models. It will be apparent that the portion of the intent ontology of FIG. 3a is intended only to provide an understanding of the intent ontology, and does not include all of the possible categories.

FIG. 3b depicts a profile that can be generated in accordance with the intent ontology of FIG. 3a. As is apparent from FIG. 3b, for each category that a user is interested in, or determined to be interested in by the profiling server 222, the profile includes a category-score pair. The score is depicted as a value between 0 and 1, although any range may be used. From the profile of FIG. 3b, a user has a high interest in ‘Autos’, is more interested in ‘Sedans’ than ‘SUVs’. The user does not have an interest in ‘BMW’ or ‘Hummer’. The user is more interested in ‘Model X’ than ‘Model Y’ by ‘Honda’, and is only somewhat interested in ‘Model Z’ by ‘GMC’.

FIG. 3c depicts an illustrative category-to-keyword mapping for the portion of the intent ontology of FIG. 3a. As is evident from FIG. 3c, each category 310 may be mapped to one or more keywords 312. When generating the keywords to use in selecting the candidate ads, the keyword generation portion 204, may select the keywords using the weighting provided by the profile, so for example words associated with sedans are given preference to words associated with SUVs.

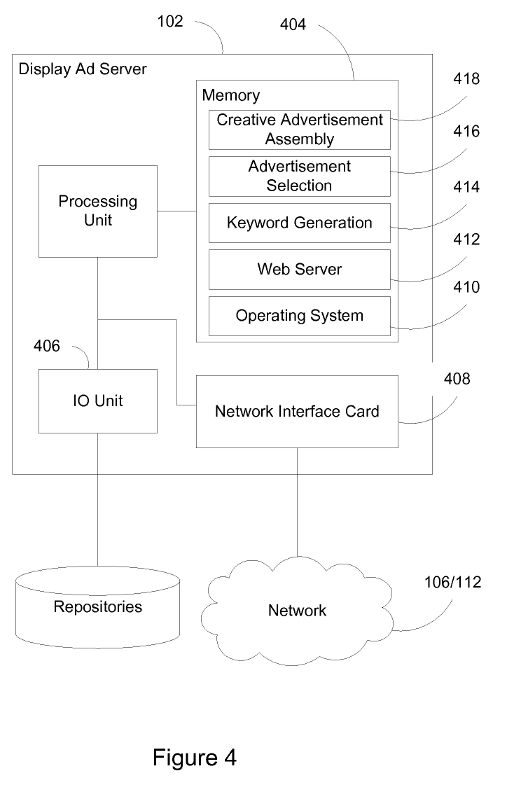

FIG. 4 depicts an illustrative implementation of an display ad server. The display ad server 102 comprises a processing unit 402 for executing instructions and controlling the components of the display ad server 102. The processing unit may comprise one or more processors each having one or more processing cores. The processing unit 402 is coupled to a memory unit 404, an input/output (IO) unit 406 and one or more network interface cards 408. The JO unit may connect the display ad server 102 to a plurality of repositories, which may be located on non volatile storage such as hard drives solid state drives, etc. The network interface card 408 couples the display ad server 102 to a network 106/112 which may comprise the ISP network 106 and the Internet 112.

The memory unit 404 stores data and instructions for execution by the processing unit 402. The data stored in the memory unit 404 may be modified as a result of the execution of the instructions by the processing unit 402. The instructions stored in the memory unit 404 include a portion for providing an operating system 410. The operating system may be any suitable operating system, such as versions of CentOS™, Microsoft Windows™, or Mac OS X™. The instructions also include a portion that provide a web server 412. The web server portion 412 may be any suitable web server such as Apache, lighttpd or nginx.

The instructions further include a portion 414 for providing the functionality of the keyword generation portion 204 described above, as well as a portion 416 for providing the functionality of the advertisement selection portion 208 described above and a portion 418 for providing the functionality of the creative assembly portion 214 described above.

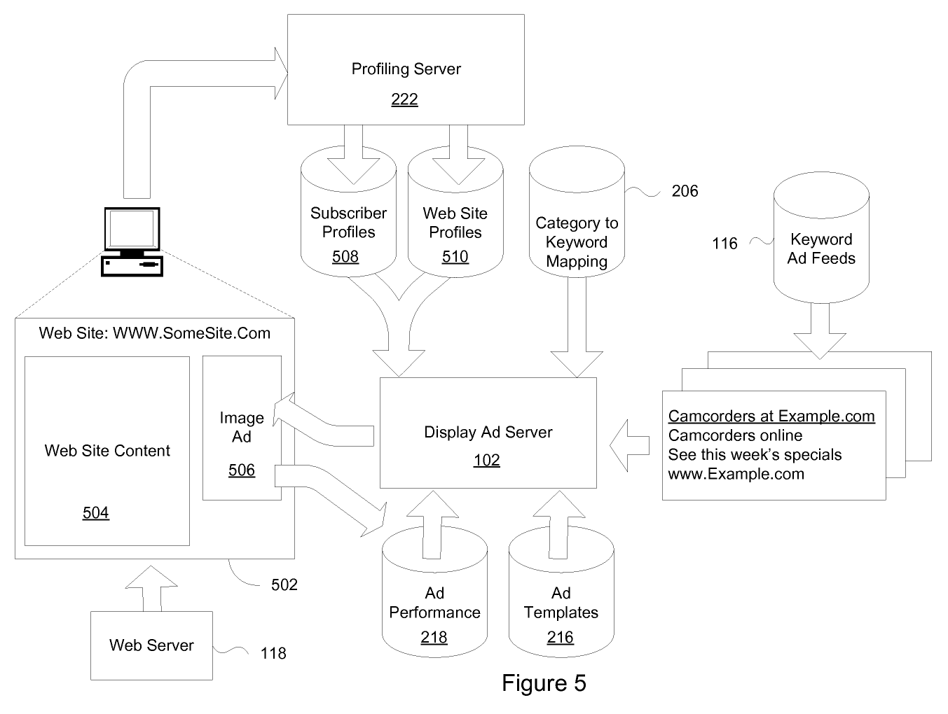

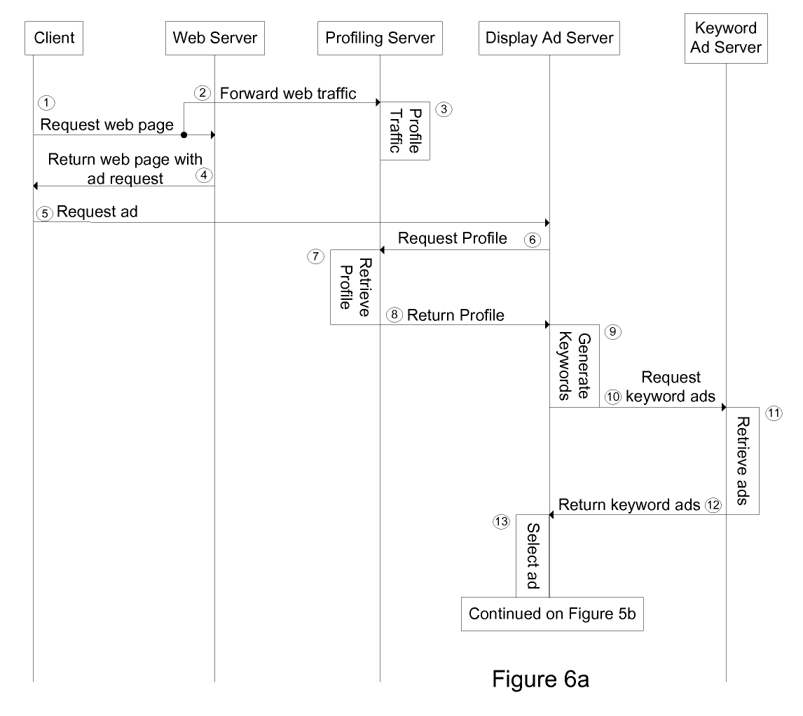

FIG. 5 depicts in a schematic an illustrative information flow between components of the environment in which the display ad generator may be used. FIGS. 6a and 6b depict in a message flow diagram a corresponding illustrative flow of messages between the components. The client 104 first sends a request for a web page (1) to the web server 118. The request is copied and forwarded (2) onto the profiling server 114. The profiling server 114 generates or updates a user profile (3) based on the content of the web page requested. The web server 118 returns a web page (4) to the client 104 in response to the request. The web page 502 includes a description of web page content 504 as well as a description of a display ad 506, including a request to the display ad server to provide the display ad. The client 104 sends a request for the display ad (5) to the display ad server 102. The display ad server 102 receives the request and requests a corresponding profile (6), either associated with the user 508 or the web page 510 or both, from the profiling server 114. The profiling server 116 retrieves the corresponding profile (7), or if one does not exist generates one based on the content of the web page, and returns the profile(s) (8) to the display ad server 102. The display ad server the generates one or more keywords (9) associated with the profile(s) using the category-to-keyword mappings repository 206. The display ad server 102 then requests keyword ads (10) from the keyword ad server 116, which retrieves the ads (11) and returns the candidate ads (12) to the display ad server 102. It will be appreciated, that the display ad server 102 may retrieve the candidate ads from a pre-fetch keyword ads repository 210 instead of directly from the keyword ad servers 116 as described above. Once the display ad server 102 has the candidate ads it selects one of them (13) based on one or more characteristics associated with the individual candidate ads or the profile or both. Once the keyword ad has been selected the display ad server 102 retrieves a template (14) from a template repository 216. The display ad server 102 then generates the an image for the display ad (15) by combining the text based keyword ad with the selected template, and generating any code required for displaying the generated image as well as any code required for tracking the impressions or clicks associated with the display ad. The display ad is then returned (16) to the client 104 and the display ad information is stored (17) in a repository. As described above, the display ad information does not need to be saved when returning the display ad, instead storing this information may be triggered by a 1×1 tracking pixel embedded in the display ad. Once the client 104 receives the display ad, it is displayed (18) in the web page 502. If the user clicks on the ad (20) a request for the ad link is sent to the display ad server 102, or an ad tracker portion, which receives the request, retrieves the associated display ad information (21), either by checking the repository, or by parsing the request for the ad link. Once the display ad information is retrieved, including a click-thru link associated with the display ad, the display ad server 102, or an ad tracker portion, returns a redirect (22) to the click thru location which causes the client's browser to display (23) the web site associated with the display ad. The display ad server 102, or the ad tracker portion, updates the information (24) associated with the display ad in order to reflect the click thru of the add.

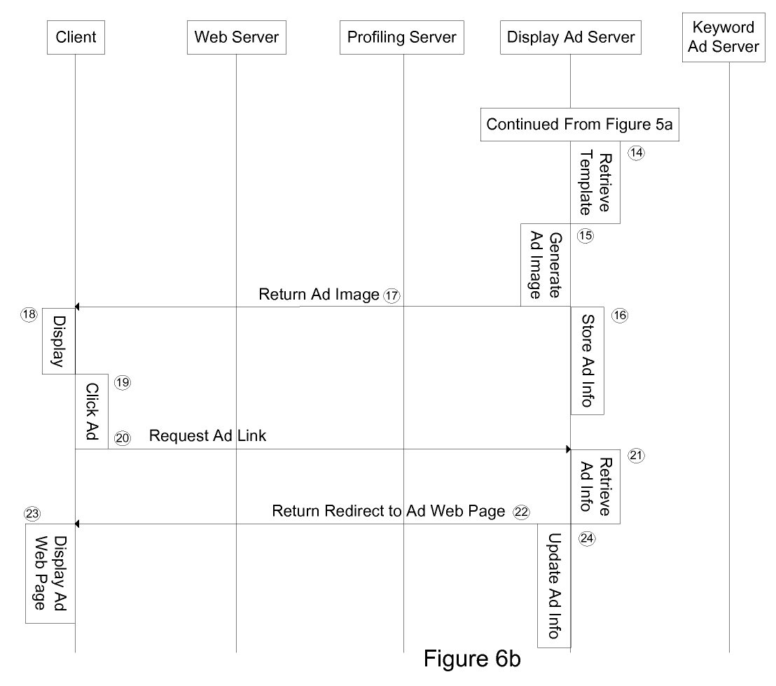

FIG. 7 depicts in a flow chart an illustrative method of generating a display ad from a text based keyword ad. The method 700 begins with receiving a profile (702). The profile may be associated with a user requesting the display ad or with the content the display ad is to be inserted into. Once the profile is received, advertising keywords are generated based on the categories (704), and possibly their associated scores, of the profile using a category-to-keyword mapping. One or more candidate ads are received based on the generated advertising keywords (706). Each of the candidate ads include a text message, a click thru link, an advertiser identifier and a cost-per-click. Each candidate ad may be associated with additional information. One ad is selected from the candidate ads based on one or more characteristics associated with the individual candidate ads (708), such as the CPC of the respective candidate ad. Once an ad has been selected, a display ad is generated based on the text message (710) associated with the selected keyword ad. The display ad may comprise an image or may comprise image as well as the code necessary to display it, along with additional code for impression and click thru tracking associated with the display ad.

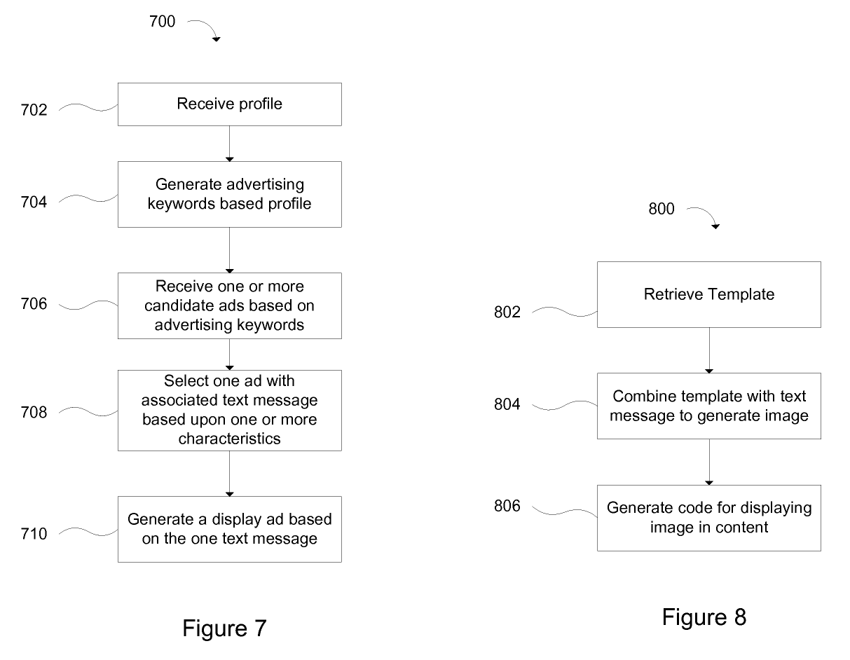

FIG. 8 depicts in a flow chart a method of generating a display ad based on a text message. The method 800 first retrieves a template (802) for example from a template repository, The template may describe various display characteristics, such as the height, width and color of the display ad. The template may be selected randomly from those templates that provide the required size of image, or they may be selected on performance information of previous display ads generated from the same template. The selected template is then combined with the text message of the selected keyword advertisement (804) in order to generate an image. If the request for the display ad was contained in an <IMG> tag, for example as <IMG SRC=ad_image_request>, the image may be returned as the display ad. If however the request was contained in, for example an <IFRAME> tag, for example as <SRC=ad_ifrane_request>, the code required for display the generated image in the iframe is generated (806), as well as any additional code for providing additional functionality such as animation, impression tracking and click thru tracking.

Using the systems and methods described herein it is possible to leverage the millions of keyword ads from search marketing advertisements to deliver these ads to ends users as behaviourally targeted display ads. As such the large supply of keyword advertisements may be used to satisfy the growing demand for display advertisements in content.

Although various illustrative embodiments have been described above, one of ordinary skill in the art will appreciate that various modifications and changes may be made to the described embodiments. For example, although the above has described the display ad system 200 as selecting one candidate ad for generating a display ad, it will be appreciated that the display ad system may be modified in order to select more than one candidate ad to be used when generating the display ad. Furthermore, the display ad may be comprised of a single image that was generated from one or more selected candidate ads, or the display ad may be comprised of a plurality of generated images.

In the above description details of various components, such as the profiling server, have been described with sufficient detail to allow one skilled in the art to understand their relationship with the display ad system. Specific implementation details of various components have been left out. One skilled in the art will appreciate that these supporting components may be replaced with other components that provide the same information, and as such their implementation is not critical to the display ad server. For example, although the profiling server has been described as providing both a user profile and possibly a web page profile, the profiling server may only provide the user profile, while the web page profile may be retrieved by other means such as application programming interface (API) calls to a repository that stores profiles for web pages.

The above description provides a system and method for generating a display ad based on a keyword ad. The components of the system, as well as their functioning have been described using various means, including flow charts specifying methods that the components of the system may implement. It is understood that the system may comprise hardware components that can be incorporated into a communication network. The hardware components may combine hardware, firmware and software in order to implement the system described herein. Alternatively, the system components may be implemented on hardware components by software expressed as a series of computer executable instructions that configure the hardware components to implement the system described herein.

What is claimed is:

1. An online advertising system comprising:
a computer readable memory for storing instructions;
a processing unit for executing the instructions stored in the computer readable memory, when executed by the processing unit, the instructions configuring the processing unit and the computer readable memory to provide:
a keyword generation unit for generating one or more advertising keywords from a received category profile defining a classification hierarchy, the generated one or more advertising keywords associated with the classification hierarchy of the received category profile, the generated one or more advertising keywords for use in selecting one or more candidate advertisement messages from a plurality of advertisement messages;
an advertisement selection unit for receiving one or more candidate advertisement messages selected from the plurality of advertisement messages, each of the received candidate advertisement messages comprising a text advertisement associated with at least one of the generated one or more advertising keywords, and selecting one advertisement message from the one or more received candidate advertisement messages based upon one or more characteristics associated with the received one or more candidate advertisement messages; and
a creative advertisement assembly unit for generating an advertisement image based on the text advertisement of the selected one advertisement message for display in network based content.

2. The system of claim 1, wherein the category profile corresponds to one of:
a user profile of a subscriber associated with requesting the advertisement image, the user profile of the subscriber comprising the classification hierarchy describing a classification of interests of the subscriber based on the subscriber's network activity;
a web page profile associated with the network content the requested advertisement image is to be displayed in, the web page profile comprising the classification hierarchy describing a classification of the network content; and
a combination of the user profile and the web page profile.

3. The system of claim 1, further comprising:
a classification repository storing associations between advertising keywords and an ontological classification hierarchy, the classification hierarchy of the category profile corresponding to a subset of the ontological classification hierarchy,
wherein the keyword generation unit generates the one or more advertisement keywords using the classification repository.

4. The system of claim 1, further comprising:
a template repository storing one or more image templates wherein the creative advertisement assembly unit generates the advertisement image based further upon an image template of the one or more image templates.

5. The system of claim 1, wherein the creative advertisement assembly unit selects the image template for use in generating the advertisement image based past performance information of advertisement images generated using the image template.

6. The system of claim 4, wherein each image template of the one or more image templates defines one or more of:
an image height;
an image width;
a font size;
a font color;
a font position;
a background color;
a background pattern;
a background image;
a background image location;
a foreground image; and
a foreground image location.

7. The system of claim 1, further comprising an advertisement performance repository for storing advertisement performance information of generated advertisement images.

8. The system of claim 7, further comprising:
an advertisement tracking unit for tracking performance information of the advertisement image,
wherein each unique advertisement image comprises a unique advertisement identifier, the advertisement identifier used by the advertisement tracking unit for tracking the performance information of the unique advertisement image.

9. The system of claim 7, wherein the advertisement performance information comprises one or more of:
an indication of the image template the advertisement image is based on;
the advertisement keywords associated with the advertisement image;
an indication of the network content the advertisement image is displayed in;
the category profiles the advertisement keywords are based on;
dates the advertisement image has been displayed;
a number of clicks the advertisement image has resulted in; and
a number of purchases the advertisement image has resulted in.

10. The system of claim 1, further comprising a server for receiving a request for an advertisement image and providing the generated advertisement image in response to the request.

11. The system of claim 1, further comprising a keyword advertisement server for receiving the request including the generated one or more advertising keywords and providing the one or more candidate advertisement messages in response.

12. The system of claim 1, wherein the one or more characteristics used to select the one advertisement message from the one or more candidate advertisement messages comprises one or more of:
a cost per click (CPC) of the candidate advertisement message;
a relevancy of the candidate advertisement message; and
past advertisement message performance.

13. The system of claim 1, further comprising:
a keyword advertisement repository for storing a plurality of keyword advertisements, associated keywords and cost per click (CPC) of each of the keyword advertisements; and
a keyword advertisement pre-fetch unit for periodically retrieving keyword advertisements, associated keywords and CPC for each of the retrieved keyword advertisements from a keyword ad server and storing the retrieved keyword advertisements in the keyword advertisement repository.

14. A computer implemented method of generating an advertisement image for display in web based content on a client computing device, the method comprising:
receiving a category profile defining a classification hierarchy;
retrieving from a keyword mapping repository one or more advertising keywords associated with the classification hierarchy of the received category profile;
receiving one or more candidate advertisement messages, each of the one or more candidate advertisement messages selected from a plurality of advertisement messages and comprising a text advertisement associated with at least one of the generated one or more advertising keywords;
selecting one advertisement message from the selected one or more received candidate advertisement messages based upon one or more characteristics associated with the received one or more candidate advertisement messages; and
generating an advertisement image based on the text advertisement of the selected one advertisement message for display in network based content.

15. The method of claim 14, wherein the category profile corresponds to one of:
a user profile of a subscriber associated with requesting the advertisement image, the user profile of the subscriber comprising the classification hierarchy describing a classification of interests of the subscriber based on the subscriber's network activity;
a web page profile associated with the network content the requested advertisement image is to be displayed in, the web page profile comprising the classification hierarchy describing a classification of the network content; and
a combination of the user profile and the web page profile.

16. The method of claim 14, wherein the one or more characteristics used to select the one advertisement message comprises one or more of:
a cost per click (CPC) of the candidate advertisement message;
a relevancy of the candidate advertisement message; and
past advertisement message performance.

17. The method of claim 14, further comprising storing historical performance information of generated advertisement images in an advertisement performance repository.

18. The method of claim 17, wherein generating the advertisement image further comprises:
retrieving an image template from a template repository storing a plurality of image templates; and
applying the advertisement message of the one advertisement message to the template.

19. The method of claim 18, wherein each image template of the one or more image templates defines one or more of:
an image height;
an image width;
a font size;
a font color;
a font position;
a background color;
a background pattern;
a background image;
a background image location;
a foreground image; and
a foreground image location.

20. The method of claim 18, wherein the image template is retrieved based on at least historical advertisement performance information stored in the advertisement performance repository.
